(19) United States
(12) Patent Application Publication
(10) Pub. No.: US 2005/0146887 A1
(43) Pub. Date: Jul. 7, 2005

(54) Dark look LED automotive lighting

(76) Inventor: Jeffrey Jose Calderas, Royal Oak, MI (US)

Correspondence Address: Laura C. Hargitt;General Motors Corporation, Legal Staff, Mail Code 482-C23-B21, PO Box 300, Detroit, MI, 48265-3000, US

(21) Appl. No.: 10/748,660

(22) Filed: Dec. 31, 2003

(51) Int. Cl. F21V 1/00

(52) U.S. Cl. 362/509

(57) ABSTRACT

Automotive lamps are configured having at least one array of light emitting diodes (LEDs) supported within the lamps. A bezel is positioned in each lamp adjacent to the LEDs, the bezel having a dark surface, the dark surface having a high gloss finish with reflector shaped surfaces to reflect light from the LEDs while absorbing visible light from external sources. A lens of light transmitting material covers the array of LEDs. The automotive lamp is especially useful as a rear combination lamp having red LEDs serving both tail light and stop light functions, as well as amber or red LEDs providing turn and hazard signals. A center, high-mounted stop lamp (CHMSL), also using an array of LEDs surrounded by a dark bezel with high gloss reflector shaped surfaces, is used in combination with a pair of the rear combination lamps. In one embodiment the rear combination lamps include side marker LEDs.

### FIELD OF THE INVENTION

The present invention is directed to dark look LED automotive lighting. More particularly, the present invention is directed to dark look LED automotive lighting, used as but not limited to external signal lighting.

### BACKGROUND OF THE INVENTION

Automobile manufacturers are constantly improving vehicles by improving reliability, improving performance and developing devices which may be useful in succeeding generations of vehicles. As an aspect of vehicle design, automotive lighting evolves as vehicles improve. As automotive lighting evolves, there is a general need to minimize power consumption and to enhance performance and reliability, while at least maintaining and perhaps improving conspicuity. With respect to automotive lighting, it is important to have lighting schemes which not only have a pleasing appearance, but for the benefit of prospective customers, differentiate vehicles using those lighting schemes from other vehicles.

Since LEDs draw relatively little current, can last the life of a vehicle, illuminate almost instantaneously and produce little heat; LEDs are of interest as automotive lighting arrangements evolve. An attractive and distinct appearance is important for LED lamps located on the rear of the vehicle because drivers necessarily focus most of their attention on the rear surface of vehicles in front of them. This is because tail lamps of preceding vehicles indicate the presence of preceding vehicles at night, and brake, turn and hazard lamps at any time caution following vehicles.

Ambient sunlight is a consideration when designing automotive lighting because ambient sunlight can obscure signal lamp functions when reflected therefrom. Since individual LEDs are typically not as bright as individual incandescent bulbs currently used as signal lamps on automotive vehicles, the reflection of ambient sunlight from signal lamps is a concern.

### SUMMARY OF THE INVENTION

In view of the aforementioned considerations, the present invention is directed to an automotive lamp comprising an array of light emitting diodes (LEDs) supported within the lamp. A bezel having a dark surface for absorbing visible light from external sources is positioned adjacent to the LEDs. The dark surface of the bezel has a high gloss finish or other reflective area at least adjacent the LEDs to reflect light from the LEDs, while the dark surface absorbs visible light from external sources. A lens of light transmitting material covers the array of LEDs.

In a further aspect of the invention, the dark surface is substantially black and the lens is clear.

In another aspect of the invention, the automotive lamp is a rear combination lamp assembly including a first array of LEDs which emit red light to function both as a tail light and as a brake light. The rear combination lamp assembly further comprises a second array of LEDs that in one embodiment emit amber light to provide turn and emergency signals which flash. A bezel surrounds the LEDs and is substantially black in color to absorb incoming light from exterior sources, such as sunlight, and includes a gloss finish to reflect light rearwardly from the LEDs. The bezel is mounted in a housing and a lens is positioned over the bezel and the arrays of LEDs.

In a preferred arrangement of the LEDs within the rear combination lamp assembly, the LEDs are arranged in vertical columns and at least a rearwardly facing reflector is positioned adjacent to the columns of LEDs.

In a preferred embodiment of energizing the LEDs, the LEDs of the first array are connected to a power supply which is connected with both a road light control system and a brake system in a vehicle. The power supply has a first mode of a reduced duty cycle for illuminating the LEDs of the first array only as taillights, and has a second mode activated by the braking system for delivering current at a higher percentage of the duty cycle to the LEDs of the first array. This illuminates the LEDs of the first array more brightly then when used as tail lights in order to provide brake lights. In still a further aspect of the invention, the power supply is connected to the second array of LEDs that emit flashing amber or red light and provides current thereto at a higher percentage of the duty cycle to contrast with the tail lights provided by the first array, as well as to be visible in conjunction with the second array, if the first array is brightly lit indicative of the vehicle's brakes being applied.

In still another aspect of the invention, the aforedescribed automotive lamp is used as a center, high mounted, stop lamp (CHMSL) comprising an array of red light emitting LEDs surrounded by a bezel which is substantially black in color to absorb incoming light from exterior sources while having a gloss finish providing reflector elements adjacent to the LEDs to reflect light from the array of red LEDs rearwardly. The bezel is mounted by a housing and a lens is positioned over the bezel and the array of red LEDs.

In further aspects of the CHMSL the red LEDs are arrayed in a line and the lens is clear.

In still another aspect of the invention the aforedescribed automotive lamps are utilized in combination in an arrangement of rear signal lamps on an automotive vehicle.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 is a schematic view illustrating light from the sun illuminating the rear of an automotive vehicle;

FIG. 2 is a rear view of the automotive vehicle of FIG. 1;

FIG. 3 is a rear view similar to FIG. 2 but showing tail lamps of the automotive vehicle illuminated;

FIG. 4 is a view similar to FIGS. 2 and 3 but showing stop signals illuminated;

FIG. 5 is a view similar to FIGS. 2-4 but showing a left turn signal illuminated;

FIG. 6 is a perspective view of a rear combination lamp configured in accordance with the principles of the present invention;

FIG. 7 is an elevation through the rear combination lamp of FIG. 6 taken along line 7-7 of FIG. 6;

FIG. 8 is an elevation taken along line 8-8 of FIG. 6;

FIG. 9 is an elevation taken along line 9-9 of FIG. 6 showing optional side marker illumination;

FIG. 10 is a rear view of a center, high mounted, stop lamp (CHMSL) configured in accordance with principles of the present invention;

FIG. 11 is an elevation taken along line 11-11 of FIG. 10;

FIG. 12 is an elevation taken along line 12-12 of FIG. 10, and

FIG. 13 is a schematic diagram showing a power supply arrangement used with each of the rear combination lamps of FIGS. 2-5, shown singularly in FIGS. 6-9.

### DETAILED DESCRIPTION

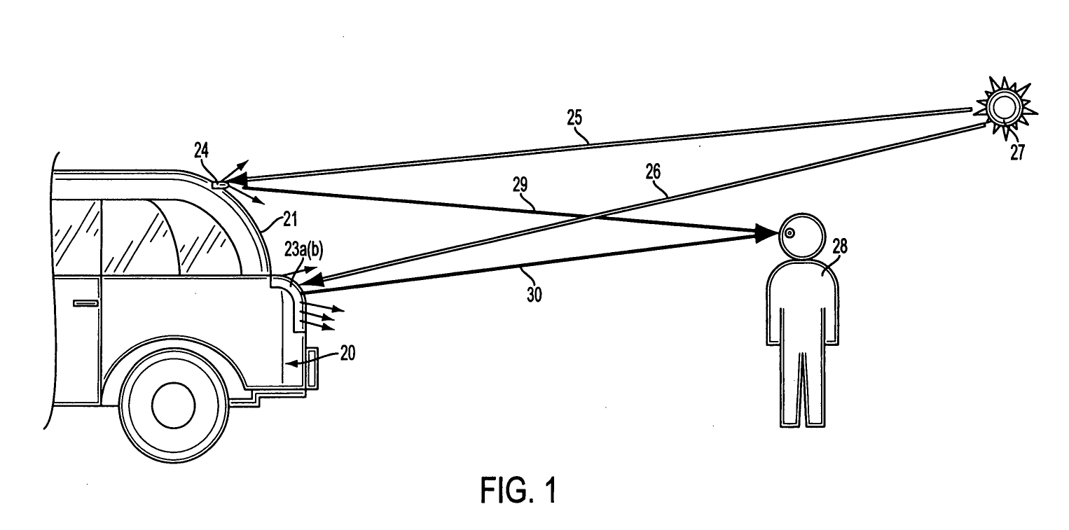

Referring now to FIG. 1 there is shown an automotive vehicle 20 having a rearwardly facing area 21 on which is disposed a pair of rear combination lamps 23a(b) and a center high mount stop lamp (CHMSL) 24. The pair of rear combination lamps 23a(b) and the CHMSL 24 are dark in color so as to not reflect exterior light rays, such as light rays 25 and 26 from an external source such as the sun 27, back to an observer 28 in a following vehicle. This is because dark objects absorb rather than reflect visible light. Since the rear combination lamps 23a(b) and CHMSL 24 absorb the externally emitted light rays 25 and 26, light rays 29 and 30 emitted by the rear combination lamps and CHMSL are not obscured by the light rays 25 and 26, and are thereby clearly visible to the observer 28. As will be explained hereinafter, this is accomplished by having dark surfaces of the lamps 23a(b) and 24 black, or substantially black in color, with a glossy surface, so that when the lamps are illuminated, they are not obscured by exterior light sources, such as light from the sun 27 or from other sources such as headlights of following vehicles.

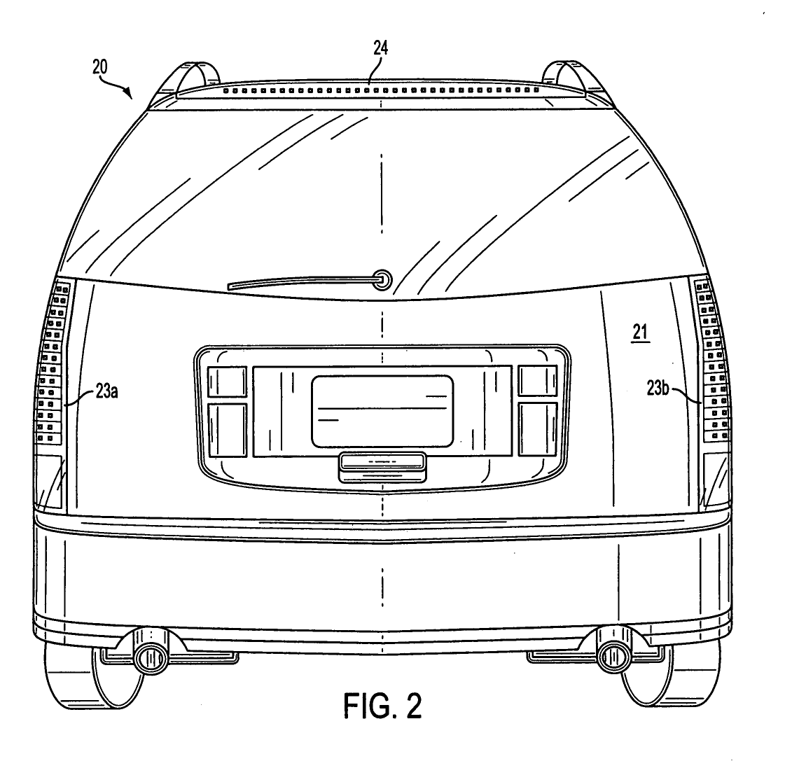

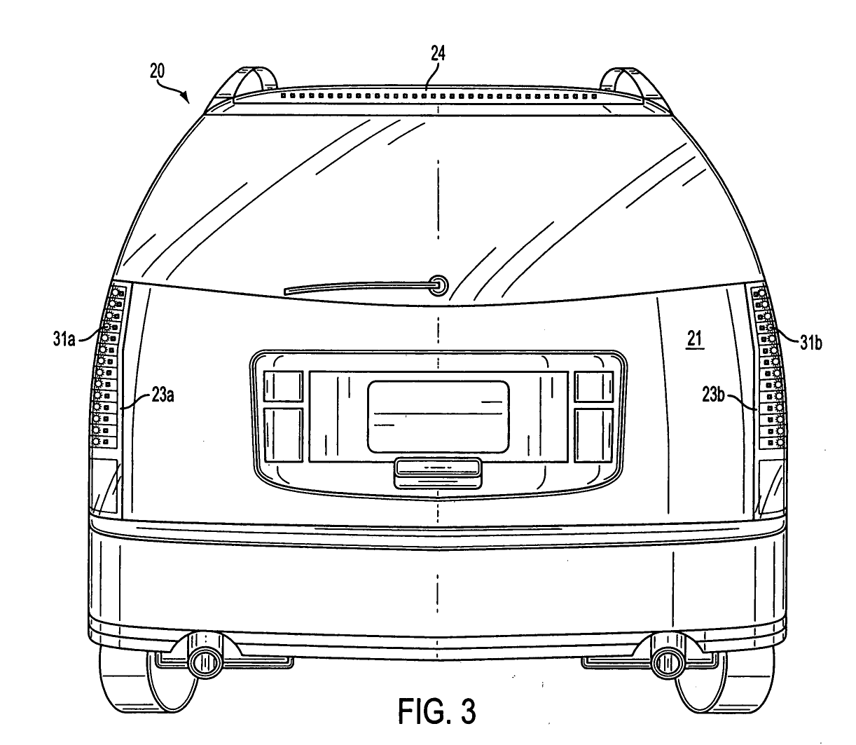

Referring now to FIGS. 2-5 where the rear area 21 of the vehicle 20 is shown, FIG. 2 shows the vehicle as it appears to a following driver in normal daylight. In FIG. 2, the rear combination lamps 23a and 23b and the CHMSL lamp 24 are not illuminated, whereas in FIG. 3, the rear combination lamps 23a and 23b are illuminated as tail signal lights 31a and 31b (preferably red in color) when the vehicle is traveling at night or twilight, in fog or in any other situation, such as with a group of other vehicles (convoy), where tail lights of vehicles are illuminated.

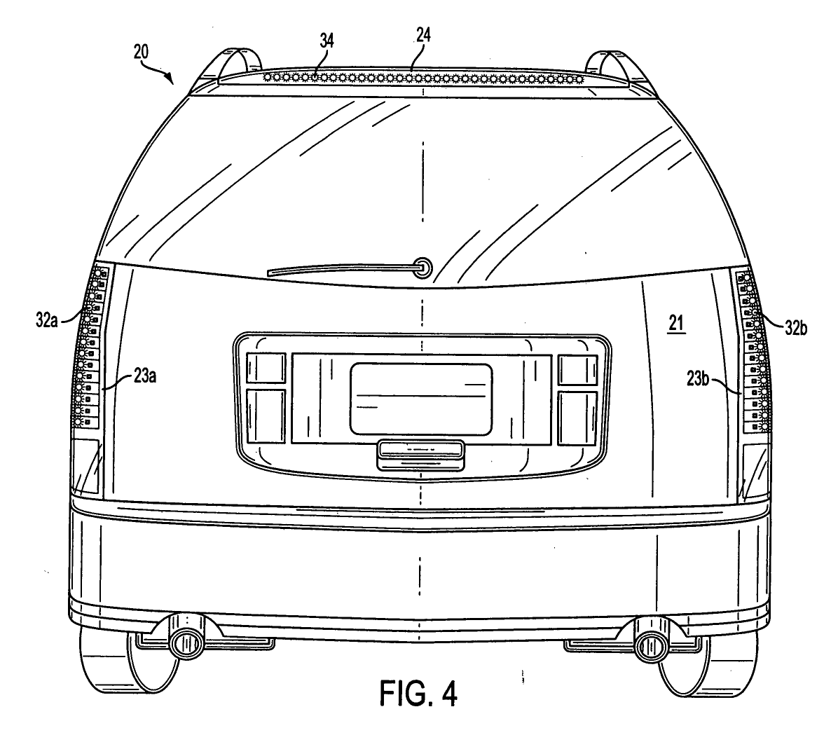

In FIG. 4, red signal stop lights 32a and 32b are substantially brighter than the red signal tail lights 31a and 31b of FIG. 3, notifying a following vehicle that brakes have been applied in the vehicle 20. In addition to illuminating the red signal stop lights 32a and 32b in the combination lamps 23a and 23b, respectively, a red signal stop light 34 in the CHMSL 24 is illuminated. The red signal stoplights 32a, 32b and 34 are substantially brighter than the red signal tail lights 31a and 31b, providing a contrasting stop signal to following vehicles.

Referring now to FIG. 5, a left turn signal is indicated by the rear combination lamp 23a as a preferably amber (or red) turn signal light 35a which flashes. While “amber” is a required color for some turn signals in jurisdictions, such as the European Union; “red” or “white” is acceptable in other jurisdictions. For emergency vehicles “orange or “blue” lights are employed and for funerals “violet” lights are also used in various ways. For conventional vehicles the general practice is to have red lamps for tail, stop and rear fog lights; amber or red lamps for turn and hazard signals, and white lamps for backing lights Since the turn signal light 35a both flashes and is bright, it contrasts with both the tail signal lights 31a and 31b and the stop signal lights 32a and 32b. If a hazards situation is being conveyed from the driver of the vehicle 20 to other drivers, then the turn signal light 35a flashes in unison with a turn signal light 35b.

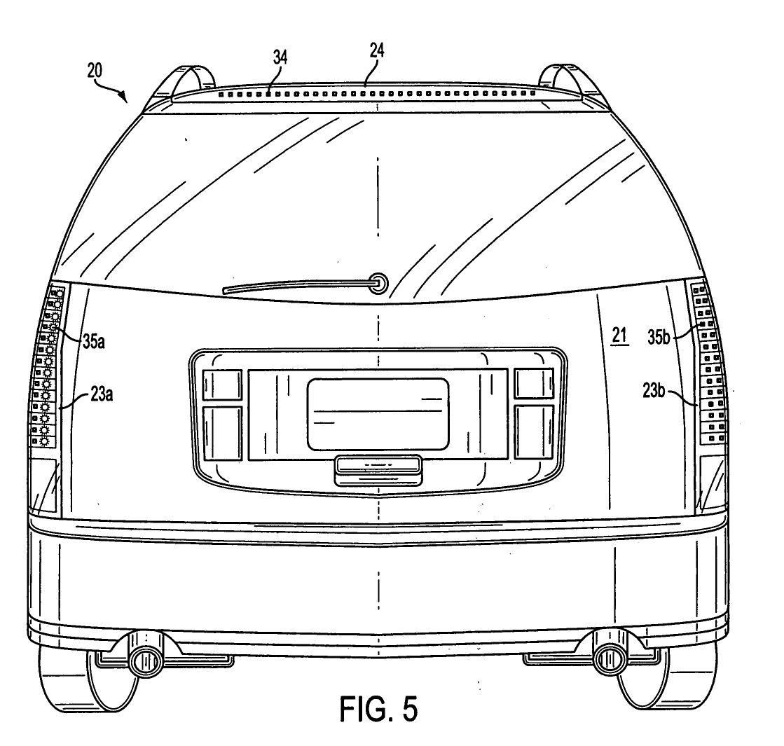

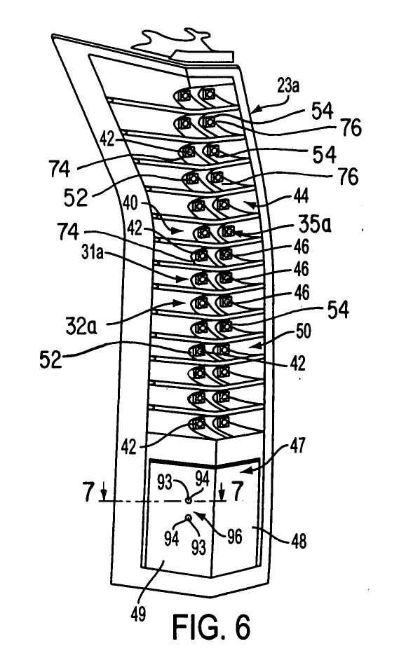

Referring now to FIGS. 6-8 one of the rear combination lamps 23a is shown, the other rear combination lamp 23b being a reverse image thereof. As is seen in FIG. 6, both the tail signal light 31 a and the stop light signal source 32a are provided by a first array 40 of first LEDs 42 that emit red light. The turn signal light 35a is provided by a second array 44 of second LEDs 46 that preferably emit either flashing amber or flashing red light. In the embodiment of FIGS. 6-8 the first array 40 of first LEDs 42 and the second array 44 of second LEDs 46 are linear and are arranged in vertical columns to provide illumination proximate the vertical edges of the rear area 21 of the vehicle 20 (see also FIGS. 2-5). Beneath the two columns formed by the first and second arrays 40 and 44 of the LEDs 42 and 46, respectively, is a passive reflector 47 having a rear panel 48 and a side panel 49. The rear panel 48 is primarily visible from the rear area 21 of the vehicle 20 and the side panel 49 primarily visible from the side of the vehicle.

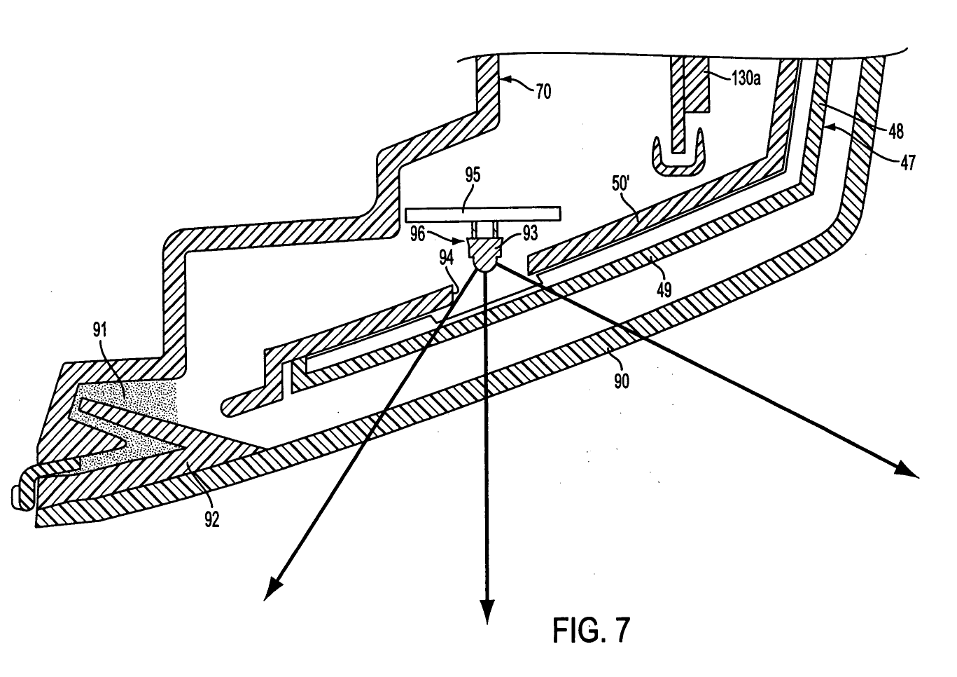

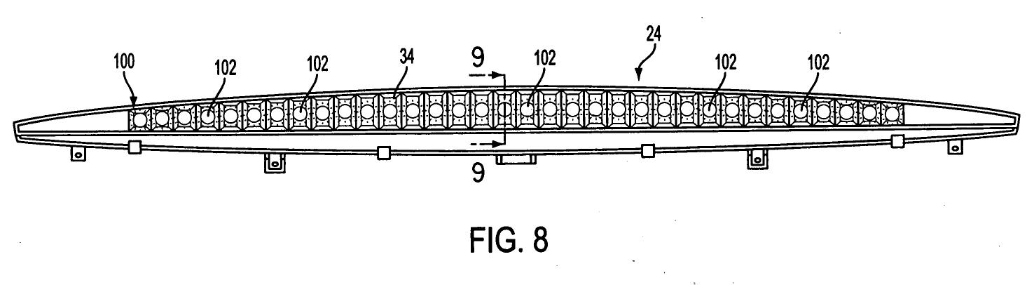

The LEDs 42 and 46 are surrounded by a bezel 50 which is dark in color to absorb rather than reflect exterior light sources such as sunlight (or following headlights), whereby the arrays of LEDs 40 and 44 are not obscured by reflected light rays from exterior light sources (see FIG. 1) when viewed by a following driver. Preferably, the bezel 50 is black or substantially black so that substantially all of the light rays 25 and 26 from an external source such as the sun 27 (see FIG. 1) are absorbed, however the bezel 50 has a high gloss surface at least in areas such as areas 52 and 54, which are directly adjacent to and extend obliquely with respect to the LEDs 42 and 46. Since at least the surfaces 52 and 54 of the bezel 50 are glossy, these surfaces reflect portions 56 and 58 of light emitted by the LEDs 42 and 46, respectively. Portions of emitted light 60 and 62 which do not reflect from the glossy surfaces 50 and 54 of the bezel 50 are directed rearwardly in a direct line of sight to the following observer. By stepping the second array 44 of LEDs 46 with respect to the first array 40 of LEDs 42, there is less interference between the stop signal light 32a and turn signal 35a emitted from the LEDs 42 and 46, respectively. As is seen in FIG. 8, the portions 52 of the bezel 50 adjacent to the LEDs 42 are above and below the LEDs 42 so as to reflect substantially all of the laterally emitted light from the LEDs 42 back toward the following vehicle. When comparing FIG. 8 to FIG. 7, it is seen that in FIG. 7 at least some of the light from the LEDs 42 in FIG. 7 emits laterally, providing at least some side illumination for the rear combination lamps 23a and 23b.

The bezel 50 is preferably made of black polycarbonate and the reflective surfaces 52 and 54 may either be at least glossy portions of the black polycarbonate or may be in the shape of small, non-metalized reflector elements surrounding each of the LEDs 42 and 46. In the preferred illustrated embodiment the entire bezel is molded of black polycarbonate with a continuous glossy surface molded therewith.

The bezel 50 is attached to a housing 70 by a pair of metal push-in clips and at least one screw utilizing a rubber sealing gasket (neither of which is shown) so that the bezel is structurally stable with respect to the housing. In a preferred embodiment, the LEDs 42 project through openings 74 in the bezel 50 and the LEDs 46 project through openings 76 in the bezel, the openings 74 and 76 being adjacent the reflective surfaces 52 and 54 of the bezel.

The first array 40 of LEDs 42 is mounted on a stamped metal circuit 80 that is press fitted or otherwise attached to the back surface of the bezel 50. The second array 44 of LEDs 46 is attached to a stamped metal circuit 84 that is also press fitted or otherwise attached to the back surface of the bezel. Alternatively, the stamped metal circuits 80 and 84 are attached to surface 81 of the housing.

Disposed over the arrays 40 and 46 of LEDs 42 and 46 is a lens 90. The lens 90 is preferably made of crystal clear (non-colored), medium impact, acrylic plastic having a black acrylic frame 92 around the entire periphery of the lens. The frame 92 is preferably molded integrally to the lens and the combination of the lens and the frame are adhered to the housing 70 using a two-part polyurethane adhesive 91 to combine the housing, lens and lens frame in an integral, closed structure protecting the LEDs 42 and 46. The housing 70 is attached removably to the rear of the vehicle 20 (FIGS. 1-5) in a conventional manner by using, for example, screws or bolts to mount the rear combination lamp 23a on the vehicle, the rear combination lamp 23b being generally configured and mounted on the vehicle in the same manner.

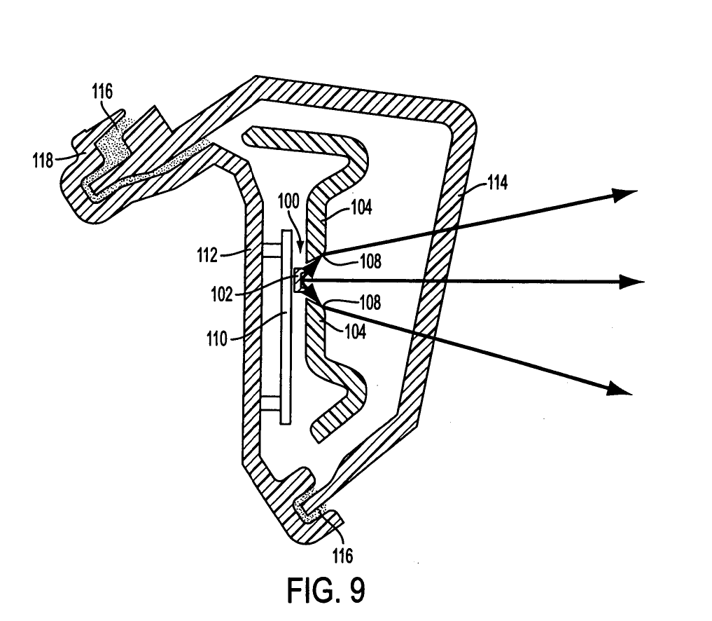

As is seen in FIG. 9, for certain markets, red side marker LEDs 93 are required. In these situations, the bezel 50′ is provided with an additional opening 94 and the LEDs 93 are supported in the housing 70 by a printed circuit board 95. Preferably, a pair of LEDs 93 provide a third array 96 of LEDs in each of the rear combination lamps 23a and 23b to provide side marker illumination for the two rear combination lamps. In a preferred embodiment, the LED or LEDs 93 are mounted to project light through a light transmitting portion of the side marker reflective panels 49 of each rear combination lamp 23a and 23b.

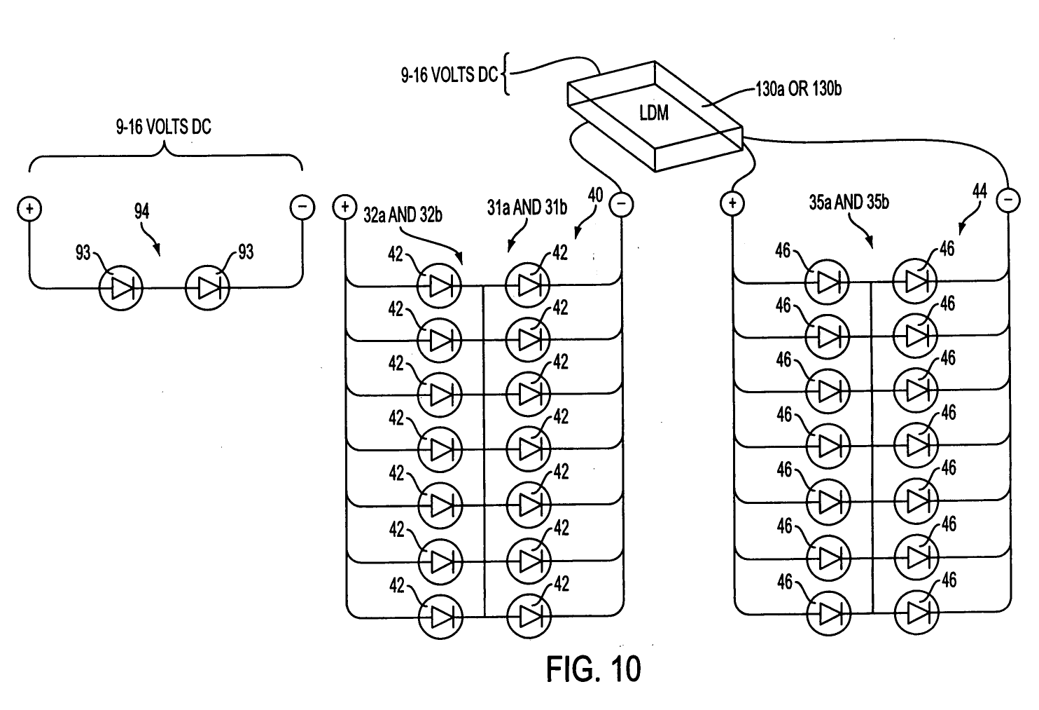

Referring now to FIGS. 10, 11 and 12 where the center, high-mounted stop lamp (CHMSL) 24 is shown in isolation, it is seen that the stop signal light 34 of the CHMSL is comprised of an additional array 100 of individual red LEDs 102. In the illustrated embodiment there are 34 LEDs. While a linear array 100 of LEDs 102 is a preferred arrangement of a CHMSL for a vehicle such as an SUV, this third array 100 of LEDs 102 may be arranged in other configurations, such as lines of LEDs arranged one above the other, or in any other arrangement conveying a signal to a following driver to “stop.”

As is seen in FIGS. 11 and 12, the additional array 100 of LEDs 102 providing the CHMSL signal light 34 cooperate with a bezel 104 that has openings 106 therein through which red light from the LEDs passes. The bezel 104 is of a dark material which absorbs exterior light such as ambient sunlight or light from a following headlight, but has reflective surfaces 108 at least adjacent the LEDs 102. In a preferred embodiment, the bezel 104 is made of a dark plastic, such as black polycarbonate, having a glossy surface which provides the reflective surfaces 108 at least adjacent each LED 102. The LEDs 102 are mounted on a circuit board 110 positioned behind the bezel 104, the circuit board being affixed to a housing 112. The housing 112 is preferably made of a plastic material and supports a clear plastic lens 114 preferably made of an acrylic material. The clear plastic lens 114 preferably has a black acrylic frame such as the frame 92 of FIG. 7. The clear plastic lens 114, which is preferably a crystal clear acrylic, is bonded to the housing 112 with a two-part polyurethane adhesive 116 to provide a permanently closed integral structure that protects the additional array 100 of red LEDs 102 for the life of the CHMSL 24.

Referring now to FIG. 13 there is shown a power supply, which is referred to in the art as an LED drive module or an LDM. An LDM 130a is mounted in the housing 70 of the left rear combination lamp 23a and an LDM 130b is mounted in the housing 70 of the right rear combination lamp 23b. The LDM modules 130a and 130b use constant vehicle current at 9-16 volts DC. When the outboard lights 31a and 31b (see FIG. 3) are functioning as taillights, the associated LDMs 130a and 130b are operating in a first mode at a 5% duty cycle to provide current to the red LEDs 42 of the first array 40 in each of the rear combination lamps 23a and 23b. Consequently, the red LEDs 42 emit light at a reduced intensity when in the first mode.

When the brake pedal of the vehicle 20 is pressed, the LDMs 130a and 130b change to a second mode during which the duty cycle is increased, preferably to a full duty cycle, which substantially brightens the red LEDs 42 in both rear combination lamps 23a and 23b, signaling a following driver that brakes have been applied in the vehicle 20.

The CHMSL light 34 is not modulated by the LDMs 130a and 130b, but is connected directly to the DC electrical system through a brake pedal detector and is illuminated immediately when the brake pedal is pressed (not shown) with current preferably at a full duty cycle, so that there are three rearwardly facing brake signal lights 32a, 32b and 34 (see FIG. 4) displayed to following vehicles when the brake pedal in vehicle 20 is pressed.

The rear turn signal lights 35a and 35b always operates at a full duty cycle and are therefore always bright when flashing to indicate a left turn 35a or a right turn 35b, or when both are flashing in conjunction to indicate an emergency situation. The second LEDs 46 contrast with the first LEDs 42 in the first arrays 40 of the two rear combination lamps 23a and 23b. This contrast indicates to following vehicles that the vehicle 20 is turning or that the vehicle is aware of a hazardous condition. The turn signal lights 35a and 35b flash together when a caution switch in the vehicle 20 is activated to indicate the presence of a hazard to following drivers. The turn signal lights 35a and 35b, positioned inboard of the tail and stop signal lights 31a and 31b, are either red or amber and contrast markedly with the red tail lights 31a and 31b and stop lights 32a and 32b because the turn signal lights 35a and 35b continuously flash.

FIG. 13. is the actual circuit diagram of the illustrated embodiment. Although the LEDs 42 and 46 are each physically in single columns in the other drawing figures, other physical arrangements of the LEDs 42 and 46 may be used, such as but not limited to circular or polygonal arrangements.

As seen in FIG. 13, if a side marker function is utilized with the rear combination lamps 23a and 23b, then the LED 93 or the array 96 of LEDs 93 are preferably energized directly by the vehicles DC electrical system to always preferably illuminate at a full duty cycle. The CHMSL 24 is preferably also energized by 9-16 volt constant DC current at a full duty cycle taken directly from the electrical system of the vehicle 20.

The present invention is also applicable to front parking and directional signal lights configured in substantial similarity with the rear combination lights 23a and 23b, wherein turn signal LEDs have dark bezels with a reflective portion or element adjacent to the LEDs, so as to indicate turns when flashed one at a time to indicate turning direction, or in unison, to indicate an emergency condition. These lights may also be used as parking lights using amber or white LEDs with dark color bezels having reflective surfaces, such as the aforementioned glossy surfaces.

From the foregoing description, one skilled in the art can easily ascertain the essential characteristics of this invention, and without departing form the spirit and scope thereof, can make various changes and modifications of the invention to adapt it to various usages and conditions.

1. An automotive lamp comprising:
an arrangement of light emitting diodes (LEDs) supported within the automotive lamp;
a bezel adjacent to the LEDs, the bezel having a dark surface for absorbing visible light, the dark surface having a high gloss finish to reflect light from the LEDs, while the dark surface absorbs visible light from other sources; and
a lens of light transmitting material covering the arrangement of LEDs.

2. The automotive lamp of claim 1 wherein the lens is clear or tinted and has a dark frame around the periphery thereof.

3. The automotive lamp of claim 1 wherein the dark surface is black and the lens is clear.

4. The automotive lamp of claim 1 wherein the LED's of the arrangement are of one color.

5. The automotive lamp of claim 1 wherein the arrangement comprises LEDs of at least two colors.

6. The automotive lamp of claim 5 wherein the arrangement of LEDs comprises at least a first array having LEDs of a first color and the second array having LEDs of a second color.

7. The automotive lamp of claim 1 wherein the lamp is a brake light lamp, a turn signal lamp, a headlamp, a backup lamp, an interior lamp or an instrument panel back-lighting lamp.

8. A rear lamp assembly for an automotive vehicle comprising:
a first array of LEDs which emit red light to provide both a tail light and a brake light;
a second array of LEDs which emit amber or red light to provide a turn signal;
a bezel for surrounding the LEDs, the bezel being substantially black in color to absorb incoming light from exterior sources and having a gloss finish to reflect light from the LEDs;
a housing mounting the bezel, and
a lens positioned over the bezel and arrays of LEDs.

9. The rear lamp assembly of claim 8 further comprising a passive reflective surface facing rearwardly and sidewardly with respect to the vehicle.

10. The rear lamp assembly of claim 9 wherein the first and second arrays extend vertically on the bezel.

11. The rear lamp assembly of claim 9 wherein the first and second arrays are separate and extend vertically in adjacent columns on the bezel.

12. The rear lamp assembly of claim 11 wherein the first array is outboard of the second array.

13. The rear lamp assembly of claim 12 wherein the reflective surface is positioned beneath the first and second arrays of LEDs.

14. The rear lamp assembly of claim 8 wherein the LEDs of the first array are connected to a power supply which is connected with both a road light control system and a brake system in the vehicle, the power supply having a first mode of a reduced duty cycle for illuminating the LEDs of the first array only as tail lights and having a second mode activated by braking system for delivering current at a higher percentage of the duty cycle to the LEDs of the first array illuminating the LEDs of the first array more brightly to provide brake lights.

15. The rear lamp assembly of claim 14 further including a connection from the power supply to the second array of LEDs which emit amber or red light, the power supply providing current at a higher percentage of the duty cycle to contrast with the first array.

16. The rear lamp assembly of claim 15 further including a third array of LEDs positioned at a side location of the lamp to provide a rear side marker light.

17. The rear lamp assembly of claim 16 wherein the third array of LEDs is energized by unmodified vehicle voltage.

18. The rear lamp assembly of claim 17 further including sidewardly facing and rearwardly facing reflectors on the bezel.

19. The rear lamp assembly of claim 8 further including a third array of LEDs positioned at a side location of the lamp to provide a rear side marker light.

20. A center high mounted stop lamp (CHMSL) comprising:
an array of red light emitting LEDs;
a bezel for surrounding and supporting the array of red LEDs, the bezel being substantially black in color to absorb incoming light from exterior sources and having a gloss finish to reflect light from the array of red LEDs;
a housing mounting the bezel, and
a lens over the bezel and the array of red LEDs.

21. The center high mounted stop lamp of claim 20 wherein the red light emitting diodes are arrayed in a line.

22. The center high mounted stop lamp of claim 21 wherein the lens is clear or tinted and has a dark frame around the periphery thereof.

23. An arrangement of rear signal lamps on an automotive vehicle, comprising:
a pair of rear lamps disposed on opposite sides of the automotive vehicle, each rear lamp having a first array of LEDs which emit red light to provide both a tail light and to provide a brake light, and a second array of LEDs which emit amber or red light to provide a turn signal;
a bezel within the lamp positioned adjacent to the LEDs, the bezel being dark in color to absorb incoming light from exterior sources and having a gloss finish to reflect light from the LEDs;
housings mounting the bezels of each rear lamp on the vehicle;
lenses positioned over each bezel and the array of LEDs of each rear lamp;
a center stop lamp positioned above the pair of rear lamps, the center stop lamp comprising an additional array of LEDs that emit red light, a bezel positioned adjacent to the LEDs of the additional array, the bezel being dark in color to absorb incoming light from exterior sources and having a gloss finish to reflect light from the LEDs of the additional array;
a housing mounting the bezel of the center stop lamp on the vehicle at a location above and between the pair of rear lamps, and
a lens positioned over the housing and additional array of LEDs of the center stop lamp.

24. The arrangement of claim 22 wherein the first and second arrays of LEDs in the pair of rear lamps are vertically extending arrays and wherein the additional array of LEDs in the center stop lamp is a horizontally extending array.

25. The arrangement of claim 24 wherein the rear lamps each include passive light reflector surfaces facing rearwardly and sidewardly with respect to the vehicle.

26. The arrangement of claim 24 wherein the rear lamps each include at least one sidewardly facing LED positioned in a sidewardly facing portion of the bezel.

27. The arrangement of claim 26 wherein the sidewardly facing LED in each rear lamp is a part of a third array including at least one other sidewardly facing LED.

28. The arrangement of claim 27 further comprising a power supply system connected with both a road light control system and a brake system in the vehicle, the power supply having a first mode of a reduced duty cycle for illuminating the LEDs of the first array only as tail lights, and having a second mode activated by the braking system and turn signal system for delivering current at a higher percentage of the duty cycle to the LEDs of the first and second arrays for the illuminating the LEDs of the first array more brightly to provide brake lights and for illuminating the LEDs of the second array for providing turn signal lights;
the LEDs of the additional array in the center stop lamp being connected directly to vehicle current for illuminating the additional array at a level similar to that of the first array in the second mode; and
the third array of LEDs being connected directly to vehicle current unmodified by the power supply.

29. The arrangement of claim 23 further comprising a power supply system connected with both a road light control system and a brake system in the vehicle, the power supply having a first mode of a reduced duty cycle for illuminating the LEDs of the first array only as tail lights and having a second mode activated by the braking system and turn signal system for delivering current at a higher percentage of the duty cycle to the LEDs of the first and second arrays for illuminating the LEDs of the first array more brightly to provide brake lights and for illuminating the LEDs of the second array more brightly to contrast with the first array when the first array is in the first mode, and
the LEDs of the third array and the additional array being connected to vehicle current to illuminate the LEDs of the third and additional array at a level similar to that of the first array when the first array is in the second mode.
